(19) United States
(12) Patent Application Publication
(10) Pub. No.: US 2008/0190769 A1
(43) Pub. Date: Aug. 14, 2008

(54) Electrodeposition Paint Pigments, Production and Use Thereof

(76) Inventors: Thomas Schuster, Lauf (DE); Christian Schramm, Hersbruck (DE); Robert Maul, Winkelhaid (DE); Harald Weiss, Furth (DE); Carolin Schmidt, Velden (DE)

Correspondence Address: OSTROLENK FABER GERB & SOFFEN, 1180 AVENUE OF THE AMERICAS, NEW YORK, NY, 100368403, US

(21) Appl. No.: 11/913,206

(22) PCT Filed: May 2, 2006
(86) PCT No.: PCT/EP2006/004088

§ 371 Date: Feb. 15, 2008

(30) Foreign Application Priority Data
May 2, 2005 (DE) 10 2005 020 763.4

(51) Int. Cl. C25D 13/00; B05D 5/12; H01B 1/00; H01B 1/02

(52) U.S. Cl. 204/471; 427/58; 252/500; 252/513; 252/514

(57) ABSTRACT

The invention relates to electrophoretic pigments, wherein the electrophoretic pigments are platelet-like metal pigments coated with at least one coating composition and the coating composition has (a) one or more binder functionalities of anodic electrophoretic paint binders and (b) one or more functional groups for effecting adhesion or binding to the pigment surface, and (c) an acid value of from 15 to 300 mg KOH/g of coating composition. The invention further relates to a method for the production of said electrophoretic pigments and to the use thereof.

The invention relates to an anodic electrophoretic paint containing metal effect pigments. The invention also relates to a method for the production of an anodic electrophoretic paint and the use of platelet-like metal effect pigments in an electrophoretic paint or in electrophoretic painting. The invention also relates to the use of the electrophoretic paint, and to a coated article.

Electrophoretic painting (EPP) is a method for applying certain water-soluble paints, so-called electrophoretic paints, to electrically conducting substrates such as a workpiece. An electrical DC voltage field is applied between a workpiece immersed in a paint bath and a counter-electrode. A distinction is made between anodic deposition—so-called anodic electrophoretic painting (AEP), in which the workpiece is wired as the anode or the positive pole, and cathodic deposition—so-called cathodic electrophoretic painting (CEP), in which the workpiece is wired as the cathode or the negative pole.

The paint binder contains functional groups of a specific polarity, which are present in a salt form due to neutralization and are thus colloidally dissolved in water. Near the electrode (within the diffusion boundary layer), hydrolysis results in hydroxide ions in CEP and H⁺-ions in AEP. These ions react with the binder salt, and the functionalized binders lose their salt form (“salt out”), with the result that they become water-insoluble and coagulate on the surface of the workpiece. As the process proceeds, the coagulated binder particles lose water due to electroosmosis operations, and the binder particles are compacted further. Finally, the workpiece is removed from the electrophoretic bath, freed from uncoagulated paint particles in a multi-stage rinsing method and baked at temperatures of from 150° to 190° C. (Brock, Groteklaes, Mischke, “Lehrbuch der Lacktechnologie” 2^{nd} Edition, Vincentz Verlag 1998, pp. 288 et seq.).

Electrophoretic painting has several economical and ecological advantages over conventional painting procedures such as painting with wet paint or powder paint.

The primary advantage deserving mention here is the precise adjustment of the layer thickness. Contrary to powder painting, even those points of the workpiece that are difficult to access are coated uniformly during electrophoretic painting. This is due to the following fact: first the binder is deposited on points having a high field strength, such as corners and edges. However, the film undergoing formation has high electrical resistance. Therefore, the flux lines shift to other regions of the workpiece and become fully concentrated at the most inaccessible regions of the workpiece on conclusion of the coating procedure, for example, those regions or points lying inside the workpiece (interior coating). Thus, workpieces having arbitrary shapes can be coated by electrophoretic painting (EPP) as long as they are electrically conductive. Furthermore, EPP is associated, to advantage, with properties such as minimum solvent emissions, optimum material yield, and non-combustibility. Coatings free from tears and sags are achieved. Electrophoretic painting is performed automatically and is thus a very economical painting procedure, particularly since it can be performed using low current densities of only a few mA/cm².

Due to the simple and extremely economical method of application, electrophoretic painting is currently used in numerous systems. The most prevalent uses to be mentioned are primers, e.g. for painting automobiles in mass production, and single-layer top coatings. Electrophoretic painting is used, for example, on radiators, control cabinets, office furniture, in building, on ironmongery and domestic appliances, in warehouse engineering and shelf construction, in air-conditioning and lighting technology, and in the production of equipment and machinery.

Anodic electrophoretic painting (AEP) is used for special applications and materials. It is primarily suitable for top paint coating of nonferrous metals providing highly transparent protective layers and for depositing colored paints. Baking results in very homogeneous, smooth, and corrosion-resistant surfaces. These surfaces have almost no variation in layer thickness (edge build-up). For this reason, articles of complex geometrical shapes also can be completely coated using this procedure. Likewise, paints applied by anodic electrophoretic painting achieve very good scores in terms of resistance to temperature and to aging. Environmental acceptability due to the substantial absence of organic solvents rounds off the advantages of anodic electrophoretic painting, making it a most efficient and attractive coating method.

The electrophoretic paints used hitherto are water-based paints, which usually contain epoxy resins, and rarely also polyacrylates as binders. Electrophoretic paints may contain conventional colored pigments, which usually include organic and inorganic colored pigments. However, the range of colors used commercially is very limited. Effect pigments have not hitherto been used in electrophoretic paints on a commercial basis.

DE 199 60 693 A1 discloses a method for anodic electrophoretic painting, which contains from 1 to 15% by weight of one or more phosphoric acid epoxy esters and/or phosphonic acid epoxy ester/s, based on the binding solids in the electrophoretic paint. DE 199 60 693 A1 states that pigments, such as, for example, metal pigments might also be added to the electrophoretic paint. However, it has been found that the mere addition of metal pigments in the anodic electrophoretic painting method disclosed in DE 199 60 693 A1 is not sufficient for depositing metal pigments onto a workpiece.

EP 0 477 433 A1 discloses metal pigments coated with synthetic resins, a very thin siloxane layer being applied as a adhesion promoter between the surface of the metal pigment and the synthetic resin layer. However, these pigments cannot be used as such for electrophoretic painting. Furthermore, this document makes no mention of electrophoretic painting.

It is an object of the present intention to provide metal pigments that can be deposited on a workpiece in a paint by the anodic electrophoretic painting process.

The metal pigments must be corrosion resistant to the water-based electrophoretic coating vehicle and must be capable of being deposited reproducibly after a bath time of more than 60 days. Electrophoretic paint coatings produced therewith should have a metallic effect preferably equal in its optical quality to that of powder paint coatings.

Another object of the present invention is to provide a method for the production of such metal effect pigments.

The object is achieved by the provision of electrophoretic pigments which are platelet-like metal pigments coated with at least one coating composition, which coating composition has
(a) one or more binder functionalities of anodic electrophoretic paint binders, and
(b) one or more functional groups for effecting adhesion or binding to the pigment surface, and
(c) an acid number of from 15 to 300 mg KOH/g of coating composition.

Preferred variants of the electrophoretic pigments are defined in subclaims 1 to 12.

The object is further achieved by the provision of a method for the production of electrophoretic pigments according to any one of claims 1 to 12, said method including the following steps:
(a) coating a metal pigment with the coating composition dissolved or dispersed in a solvent,
(b) optionally drying the metal pigments coated with the coating composition in step (a),
(c) optionally working the metal pigments dried in step (b) to a paste,
(d) optionally neutralizing the metal pigments obtained in step (a) or step (c).

Another development of the method of the invention is defined in subclaim 14.

The object of the invention is also achieved by the use of electrophoretic pigments according to any one of claims 1 to 12 in an electrophoretic paint or for electrophoretic painting.

The metal pigments may consist of metals or alloys selected from the group consisting of aluminum, copper, zinc, brass, iron, titanium, chromium, nickel, steel, silver, and alloys thereof and mixtures thereof. To be preferred in this case are aluminum pigments as well as brass pigments, aluminum pigments being particularly preferred.

The metal pigments are always of a platelet-like nature. These are to be understood as pigments in which their average longitudinal extent is at least ten times, preferably at least twenty times and more preferably at least fifty times their average thickness. For the purposes of the invention, the term “metal pigments” always refers to platelet-like metal pigments.

The metal pigments used in the electrophoretic paint have average longitudinal extents, which are determined by means of laser granulometry (Cilas 1064, supplied by Cilas) as ball equivalents and represented as the d₅₀ value of the corresponding cumulative size distribution curve. These d₅₀ values range from 4 to 35 μm and preferably from 5 to 25 μm. It has been found, surprisingly, that it is virtually impossible to deposit very large pigment particles having a d₅₀ value of over 100 μm. Apparently, the migration and deposition properties are considerably reduced in the case of larger particles. Of such coarse pigment distributions, only fractions of less than approx. 100 μm (fine-grained portion) are deposited. However, this considerably reduces the size and size distribution of the deposited particles compared with the particles originally used. Smaller particles are preferred for this reason. At a d₅₀ value ranging from approx. 4 μm to 35 μm, the pigments of the invention are readily deposited over their entire size distribution. Furthermore, at sizes ranging from 2 μm to 35 μm, pigments enable bath times or a bath stability of more than 60 days to be achieved. Particles having a d₅₀ of less than 4 μm are too fine to produce an attractive visual effect. Another effect is that gassing problems may occasionally occur in the aqueous electrophoretic paint medium in such cases due to the very high specific surface area of the fine pigments.

The average thickness of the metal pigments of the invention, on the other hand, is from 40 to 5,000 nm, preferably from 65 to 800 nm and more preferably from 250 to 500 nm.

Electrophoretic paints are always water-based systems. For this reason, metal pigments present in electrophoretic paint must be provided with a protective layer, in order to combat the corrosive effect of water on the metal pigment. Furthermore, they must have suitable surface charges, in order to possess sufficient electrophoretic mobility in the electric field.

These requirements are met, surprisingly, when metal pigments are coated with an organic coating composition which has binder functionalities of anodic electrophoretic binders, one or more functional groups for effecting adhesion or binding to the pigment surface, and an acid number of from 15 to 300 mg KOH/g of coating composition.

For the purposes of the invention, the term “binder functionalities” means functional groups such as characterize binders of an anodic electrophoretic paint.

For the purposes of the invention, the term “adhesion” means non-covalent interactions, such as hydrophobic interactions, hydrogen bonding, ionic interactions, van der Waals forces, etc., that lead to immobilization of the coating composition on the surface of the pigment.

The term “binding” means, for the purposes of the invention, covalent bonds which lead to covalent immobilization of the coating composition on the surface of the pigment.

According to a preferred development of the invention, the metal pigments are leafing metal pigments and/or metal pigments which are coated with a synthetic resin layer and which have been treated with at least one coating composition containing suitable binder functionalities for electrophoretic paints.

The leafing metal pigments are metal pigments which accumulate on the surface, or close to the surface, of the binder due to incompatibility of their surface-chemical properties with the surrounding binder. All leafing metal pigments known in the prior art can be used. Preferably they are metal pigments ground and/or finally polished with preferably saturated, fatty acids containing from 10 to 30 carbons. The fatty acids can be linear or branched. The leafing pigments are preferably ground and/or finally polished with stearic acid and/or palmitic acid. The stearic acid and palmitic acid used are of technical quality, i.e. they contain small quantities of higher and/or lower fatty acid homologs.

Furthermore, leafing metal pigments may be metal pigments that have been treated with additives containing alkyl chains. Examples thereof are decylphosphonic acid or alkyl alcohol phosphoric acid esters such as the product FB 7234/S supplied by Zschimmer & Schwarz GmbH & Co (Max-Schwarz-Str. 3-5, D-56112 Lahnstein/Rhine).

Examples of aluminum pigments having leafing properties are the leafing Hydroxal series supplied by Rckart and the leafing Silver Dollar EBP 251 supplied by Silberline, USA.

Surprisingly, the use of the metal pigments of the invention based on a leafing metal pigment, likewise produces, after electrophoretic painting, an extremely brilliant metallic coat of paint that likewise has a leafing effect.

However, a particularly surprising fact is that these leafing metal pigments are permanently incorporated in the paint layer and display no abrasion. This has hitherto not been been possible to a reliable extent when using leafing metal pigments in, say, powder paint.

The metal pigments coated with synthetic resins contain a coating of polymers. These polymers are polymerized on the metal pigments starting from monomers. The synthetic resins comprise acrylates, methacrylates, esters and/or urethanes. In a preferred embodiment, the coated metal pigment is coated with at least one methacrylate and/or acrylate. Particular preference is given to those metal pigments that have been produced according to the teaching of EP 0 477 433 A1, incorporated herein by reference. Such pigments contain, between the metal pigment and the synthetic resin coating, an organofunctional silane, which serves as adhesion promoter. Coatings containing, preferably poly-cross-linked acrylates and/or methacrylates are preferred. Such coatings already provide a certain degree of, but not absolutely reliable, protection from the aqueous medium of electrophoretic paints. Similar pigments are described in DE 36 30 356 C2, the difference being that an ethylenically unsaturated mono- or di-carboxylate and/or mono- or di-phosphorate serves as the adhesion promoter.

Examples of such cross-linkers are: tetraethylene glycol diacrylate (TEGDA), triethylene glycol diacrylate (TIEGDA), polyethylene glycol 400 diacrylate (PEG400DA), 2,2-bis(4-acryloxyethoxyphenyl)propane, ethylene glycol dimethacrylate (EGDMA), diethylene glycol dimethacrylate (DEGDMA), triethylene glycol dimethacrylate (TRGDMA), tetraethylene glycol dimethacrylate (TEGDMA), butyl diglycol methacrylate (BDGMA), trimethylol propane trimethacrylate (TMPTMA), 1,3-butanediol dimethacrylate (1,3-BDDMA), 1,4-butanediol dimethacrylate (1,4-BDDMA), 1,6-hexanediol dimethacrylate (1,6-HDMA), 1,6-hexanediol diacrylate (1,6-HDDA), 1,12-dodecandiol dimethacrylate (1,12-DDDMA), neopentyl-glycol dimethacrylate (NPGDMA). Trimethylol propane trimethacrylate (TMPTMA) is particularly preferred. These compounds are commercially available from Elf Atochem Deutschland GmbH, D-40474 Duesseldorf Germany or Rohm & Haas, In der Kron 4, 60489 Frankfort-on-Main, Germany.

The thickness of the synthetic resin coating is preferably from 2 to 50 nm, more preferably from 4 to 30 nm and most preferably from 5 to 20 nm. The content of synthetic resin, based on the weight of the uncoated metal pigment, individually depends on the size of the metal pigments and is preferably from 1 to 25% by weight, more preferably from 2 to 15% by weight and most preferably from 2.5 to 10% by weight.

The coating composition is applied to the metal pigments after the formation of the synthetic resin layer. The synthetic resin layer can envelop the pigments completely. However, it may surround the pigments incompletely or have cracks. The use of a coating composition having binder functionalities of anodic electrophoretic paint binders makes it possible to prevent the occurrence of possible corrosion sites, which can be caused by such cracks or by an incomplete coating on the metal pigment. Particularly if the coating composition binds to the metallic pigment surface, it can penetrate into such gaps or cracks in the synthetic resin coating and thus provide the requisite corrosion resistance. Metal pigments which are coated only with synthetic resin and are not treated with coating compositions are not effective in anodic electrophoretic painting.

During electrophoretic painting, conventional colored pigments added to an electrophoretic paint are deposited on the workpiece by a more or less random process. The electrophoretic paint is constantly vigorously stirred during deposition. The transport of material to the workpiece takes place substantially by this means (convection). An electrophoretic migration of the charged binder particles in the electric field takes place only within the Nernst diffusion layer as it forms. The concentration of the colored pigments in the deposition bath is very high (approx. 10% by weight). The colored pigments are entrained by the depositing binder. No electrophoretic migration of the colored pigments takes place in the electric field.

Metal pigments per se cannot be used in electrophoretic paints. Even if they are made corrosion-resistant to the aqueous medium of the electrophoretic paint by a suitable protective layer, for example, a metallic oxide or a synthetic resin, either they are not deposited at all or they are no longer deposited after an initial deposition phase lasting a few hours or days (insufficient bath stability).

It has now been found, surprisingly, that the metal pigments of the invention can be reliably deposited over long periods of time in the anodic electrophoretic paint, and the electrophoretic paint has a bath stability of more than 60 days. The metal pigments of the invention present in the anodic electrophoretic paint are sometimes still reliably deposited on the workpiece after 60 days, preferably after 90 days.

The coating composition in this case displays suitable or typical binder functionalities for anodic electrophoretic paints and has an acid number of from 15 to 300 mg KOH/g of coating composition.

It is presumed that the metal pigments of the invention contain charged or charge-producing functional groups on their surface. The electrophoretic pigments of the invention are preferably negatively charged on the surface. The coating composition preferably displays functionalities that correspond to those of the binder or binders used in the respective electrophoretic paint. It is also preferred that the functional groups adhering to, or binding to, the pigment surface be acidic or negatively charged. It is presumed that the surface of the metal pigments of the invention is adapted in this way chemically to the binders of the electrophoretic paint. This permits the metal pigments in the electrical field, on the one hand, to migrate electrophoretically, and on the other, to participate in the disposition mechanism of the electrophoretic paints.

The coating composition used in the electrophoretic pigments of the invention is preferably capable of being deposited anodically.

By its chemical nature, the coating composition may be an additive or binder or a binder component. The binder functionalities may be selected from the group consisting of polymerized polyepoxides, epoxy resin esters, modified polyepoxides, silicone resins, polyurethanes, polyesters, polyacrylates, polymethacrylates, polyacrylates/-methacrylates, melamine resins, maleates, maleate oils, maleated polybutadiene resins, and mixtures thereof. It is preferred that the coating composition have at least three, e.g, four, five, six, or more binder functionalities, which may be the same or different.

Thus, polyesters may be used, for example. However, the latter contain, for anodic electrophoric paints, preferably non-esterified carboxyl groups or polyol groups that serve as functional groups to effect binding to the metal pigment surface.

Furthermore, the coating composition may have, for example, fully polymerized epoxy units. This is to be understood to mean polyether units as well as resins based on phenols or bisphenols that have been reacted polymer-chemically with epoxides.

The coating compositions also contain functional groups that cause, or are capable of causing, adhesion and/or binding to the pigment surface. The pigment surface may in this case be the metal pigment surface direct. However, it may alternatively be the metal pigment surface coated with fatty acid(s) or with synthetic resin. In this way, the coating compositions can be anchored reliably and adequately to the metal pigments.

These functional groups are, for example, phosphonic acids, phosphonic acid esters, phosphoric acids, phosphoric acid esters, carboxylates, sulfonates, and/or polyols.

Such functionalized coating compositions contribute to the corrosion stability of the metal pigments in the aqueous electrophoretic paint. Surprisingly, gassing, e.g., the evolution of hydrogen from leafing aluminum pigments, can also be effectively suppressed.

The coating compositions of the metal pigments of the invention must also possess an acid number of from 15 to 300 mg KOH/g of coating composition. The acid groups necessary for this may be derived from the functional groups that cause, or are capable of causing, adhesion or binding to the pigment surface.

These acid groups presumably impart to the electrophoretic pigment of the invention sufficiently negative surface charges, on the one hand, to be well dispersed in the predominantly aqueous medium of the electrophoretic paint, and on the other, under the conditions of anodic electrophoric coating, to be able to travel electrophoretically in the electrical field, which can also be referred to as migration, in order ultimately to be able to participate in the deposition mechanism inside the Nernst diffusion layer at the anode by means of the above-elaborated mechanism.

The coating composition preferably has an acid number of from 17 to 150 mg KOH/g of coating composition and more preferably from 20 to 100 mg KOH/g of coating composition.

Coating compositions with acid numbers below 15 mg KOH/g of coating composition have been found to be unsuitable.

The acid number of the coating composition can be determined as specified in the standard DIN EN ISO 3682.

The coating composition may be at least partially detached from the metal pigment in advance by suitable extraction processes known to the person skilled in the art and isolated, reweighed and analyzed by commonly used analytic procedures.

Modified ester resins are preferably used as coating compositions for the electrophoretic pigments of the invention. Modified polyester resins as well as polyol-modified polyester resins are particularly preferred. An example is the product Setal L 6306 SS-60 (supplied by Akzo Nobel). This is a polyol-modified polyester having an acid number of about 20 mg KOH/g and a hydroxyl content of 2.7%.

Modified epoxy resins and/or acrylate resins are also preferred as coating compositions for the electrophoretic pigments of the invention. Epoxy resins modified with phosphoric acid derivatives, phosphoric acid ester derivatives, phosphonic acid derivatives and/or phosphonic acid ester derivatives or mixtures thereof are preferred. Such functions apparently possess an adequate negative charge and in addition—especially in the case of aluminum pigments—improve the gassing stability. Products of the Resydrol series (supplied by Akzo Nobel, or Cytec, Graz, Austria) have been found to be highly suitable coating compositions as epoxy resin-modified and/or acrylate resin-modified phosphoric acid esters.

The coating compositions are preferably used in quantities ranging from 1 to 200% by weight, based on the weight of the uncoated metal pigment. If used in a quantity below 1%, their effect is too small and the metal pigments are no longer deposited reliably, particularly after a bath time of 60 days. If used in a quantity exceeding 200% by weight, an unnecessarily high amount of coating composition is used. The appropriate amount of metal pigments has to be incorporated in the electrophoretic paint. In this case, excess coating composition could adversely affect the properties of the electrophoretic paint. The coating compositions are preferably used in quantities ranging from 10 to 150% by weight, more preferably from 20 to 100% by weight and very preferably from 30 to 70% by weight, always based on the weight of the uncoated metal pigment. These data in each case refer to the coating composition itself and not to any solvent possibly present in which the coating composition may have been provided in its commercial stock form.

The coating composition can, but need not, completely envelop the metal pigments.

In another embodiment of the invention, those binders are used as coating compositions for the metal pigments that are used as binders in anodic electrophoretic painting. However, in this case, the binders must have the functional groups mentioned above in order to permanently adhere or bind to the effect pigment in a suitable manner, since otherwise the coating might delaminate from the metal pigment and ultimately detach itself therefrom in the aqueous electrophoretic paint. Such binding may alternatively take place, if appropriate, if use is made of other suitable binders, such as organofunctional silanes or modified binders provided with adhesive groups for the effect pigment.

Binders that are suitable for anodic electrophoretic paints have acid numbers of preferably from 15 to 300 mg KOH/g, more preferably from 25 to 160 mg KOH/g of binder and very preferably from 50 to 130 mg KOH/g of binder. These binders preferably have a hydroxyl number of from 0 to 160 mg KOH/g of binder and more preferably from 30 to 100 mg KOH/g of binder.

The following resins are suitable for anodic electrophoretic paints: polyacrylate resins, polymethacrylate resins, polyester resins, polyurethane resins, epoxy resins, epoxy resin esters, modified epoxy resins and silicone resins. Furthermore, combinations of these functionalities, e.g., urethanized polyester resins, acrylated polyester resins or polyurethane resins, polyol-modified polyesters, maleated oils or maleated polybutadiene resins are suitable.

For binding the metal pigment to the coating composition, organofunctional silanes of the formula R_{z}Si(OR′)_{(4-z)} may be used. Here R is an organofunctional group, R′ an alkyl group containing 1 to 6 carbons and z an integer from 1 to 3.

R′ is preferably ethyl or methyl and R preferably contains acrylate groups, methacrylate groups, vinyl groups, isocyanato groups, hydroxyl groups, carboxyl groups, thiol groups, cyano groups, or ureido groups, as the functional groups.

Such silanes are commercially available. For example, they include many representatives of the products manufactured by Degussa, Rheinfelden, Germany and marketed under the trade name “Dynasylan®” or the Silquest® silanes supplied by OSi Specialties, or GENOSIL® supplied by Wacker, Burghausen, Germany.

Examples thereof include 3-methacryloxypropyltrimethoxysilane (Dynasylan MEMO, Silquest A-174NT), vinyltri(m)ethoxysilane (Dynasylan VTMO and VTEO, Silquest A-151 and A-171 respectively), 3-mercaptopropyltri(m)ethoxysilane (Dynasylan MTMO or 3201; Silquest A-189), 3-glycidoxypropyltrimethoxysilane (Dynasylan GLYMO, Silquest A-187), tris(3-trimethoxysilylpropyl)isocyanurate (Silquest Y-11597), gamma-mercaptopropyltrimethoxysilane (Silquest A-189), bis(3-triethoxysilylpropyl)polysulfide (Silquest A-1289), bis(3-triethoxysilyl)disulfide (Silquest A-1589), beta-(3,4-epoxycyclohexyl)ethyltrimethoxysilane (Silquest A-186), gamma-isocyanatopropyltrimethoxysilane (Silquest A-Link 35, Genosil GF40), (methacryloxymethyl)trimethoxysilane (Genosil XL 33), (isocyanatomethyl)trimethoxysilane (Genosil XL 43).

The functional groups of the silane must be caused to react with chemically complementary groups of the coating composition in order to form a covalent bond between the organofunctional silane and the coating composition.

A method for the production of the metal pigments of the invention includes coating the metal pigments with the coating composition. It includes the following steps:
(a) coating a metal pigment with the coating composition dissolved or dispersed in a solvent,
(b) optionally drying the metal pigments coated in step (a) with the coating composition,
(c) optionally working the metal pigments dried in step (b) to a paste,
(d) optionally neutralizing the metal pigments obtained in step (a) or step (c).

The coating can be applied in a variety of ways. For example, the metal pigment may be placed in a mixer or kneader in the form of a paste, e.g., in an organic solvent or in a mixture of organic solvent and water. Then the coating composition is added and allowed to act on the metal pigment for at least 5 minutes. The coating composition is preferably added in the form of a solution or dispersion. It can be an aqueous solution or a predominantly organic solution.

Furthermore, the metal pigment may initially be dispersed in a solvent. The coating composition is then added with stirring. The solvent in which the coating composition is dissolved should preferably be miscible with the solvent in which the metal pigment is dispersed. If necessary, elevated temperatures up to the boiling point of the solvent (mixture) may be used. However, room temperature is usually sufficient for the coating composition to effectively coat the metal pigment.

Thereafter, the pigment is freed from solvent and either dried to form a powder and/or worked to a paste in another solvent, if required. Water, alcohols, such as, ethanol, isopropanol, n-butanol, or glycols, for example, butyl glycol, are suitable. The solvent should be miscible with water. The pigment of the invention is marketed in the form of a paste or powder. The pastes have a nonvolatile content of from 30 to 70% by weight, based on the total paste. The paste preferably has a nonvolatile content of from 40 to 60% by weight and more preferably from 45 to 55% by weight.

The form of the paste is preferably a dust-free and homogeneous stock form of the electrophoretic pigments of the invention. The electrophoretic pigments of the invention may also exist in dust-free and homogeneous forms, such as pellets, sausage-shaped extrudates, tablets, briquettes or granules. The above-noted stock forms can be produced by pelleting, extruding, tabletting, briquetting or granulating by methods known to the person skilled in the art. The solvent is substantially removed from these compacted stock forms. The residual solvent content is ordinarily less than 15% by weight, preferably less than 10% by weight and more preferably between 0.5 and 5% by weight.

The coating composition may exist in a neutralized or partly neutralized form prior to application to the metal pigment. However, it may alternatively be neutralized after the coating process. The neutralization/partial neutralization can also be accomplished when the pH of the electrophoretic paint is adjusted.

The usual bases are suitable for neutralizing the acid functionalities. Examples thereof are: NaOH, KOH, ammonia, LiOH, amines such as diethylamine, triethylamine, morpholine, ethylenediamine or alkanolamines such as dimethylaminoethanol, dimethylamino-2-methylpropanol or trimethylethanolamine, or mixtures of various bases. Enough base should be used that at least 25% and preferably 40% of the acid groups of the metal pigment coated with the coating composition exist in neutral form. In this case, functional groups which may stem from the metal pigment itself are counted as acid groups. These may be, for example, acrylic acid functions, in the case of a metal pigment coated with synthetic resins, or stearic acid, in the case of leafing metal pigments as starting pigments.

The steps (a) and (b) may be combined into one step by applying the coating composition as a solution or dispersion to metal pigments traveling in a stream of gas.

Particularly when the coating composition is an anodic electrophoric paint binder, the electrophoretic pigments of the invention can be produced by the method comprising the following steps:
a) creating a solution or dispersion of a binder suitable for electrophoretic paints in an organic solvent,
b) coating the metal pigment with the binder by
   i) dispersing the metal pigment in the solution or dispersion of a) and subsequently spraying or
   ii) spraying the solution or dispersion of a) on metal pigments turbulized in a gas stream,
c) optionally drying the binder-coated metal pigments in a moving gas stream,
d) optionally working the pigment to a paste in water and/or an organic solvent,
e) optionally neutralizing the mixture with a base.

Neutralizing and working the pigments to a paste can in this case be accomplished as described above.

The steps b) and c) can be combined to a single method step by performing the spraying and drying in a spray-dryer. In this case, preferably highly volatile solvents are used such as acetone and/or ethyl acetate.

The electrophoretic pigments of the invention are used in anodic electrophoretic paints or in electrophoretic painting.

The following examples illustrate the invention in more detail but without restricting the scope thereof.

### EXAMPLE 1 OF THE INVENTION

80 g of a paste of 9 g of PCA 214 (aluminum pigment coated with organic polymers and having a d₅₀ of 32 μm; supplied by Eckart GmbH & Co. KG) are mixed with 80 g of butyl glycol to form a homogeneous pigment paste. Then 40 g of SETAL 6306 SS-60 (polyol-modified polyester supplied by Akzo Nobel, P.O. Box 79, 4600 AB Bergen op Zoom, Netherlands) is added with stirring. This pigment paste is allowed to stand overnight.

### EXAMPLE 2 OF THE INVENTION

The production of the electrophoretic paint takes place as in Example 1, except that an aluminum effect pigment having an average particle size d₅₀ of 18 μm, PCA 9155 (supplied by Eckart GmbH & Co. KG, Fuerth, Germany) is used.

### EXAMPLE 3 OF THE INVENTION

The production of the electrophoretic paint takes place as in Example 1, except that a leafing aluminum effect pigment having an average particle size d₅₀ of 18 μm, VP 53 976 (supplied by Eckart GmbH & Co. KG) is used.

### EXAMPLE 4 OF THE INVENTION

80 g of a paste of 9 g of PCA 214 (aluminum pigment coated with organic polymers and having a d₅₀ of 32 μm; supplied by Eckart GmbH & Co. KG, Fuerth, Germany) are mixed with 80 g of butyl glycol to form a homogeneous pigment paste. 40 g of Resydrol AH 509w/45WA (phosphoric acid-modified acrylate resin; supplied by Cytec, Graz, Austria) are then added with stirring. This pigment paste is allowed to stand overnight.

### EXAMPLE 5 OF THE INVENTION

The production of the electrophoretic paint takes place as in Example 4, except that an aluminum effect pigment having an average particle size d₅₀ of 18 μm, PCA 9155 (supplied by Eckart GmbH & Co. KG) is used.

### EXAMPLE 6 OF THE INVENTION

The production of the electrophoretic paint takes place as in Example 4, except that a leafing aluminum effect pigment having an average particle size d₅₀ of 18 μm, VP 53 976 (supplied by Eckart GmbH & Co. KG) is used.

The production of the electrophoretic paint takes place as in Example 1.

### COMPARATIVE EXAMPLE 7

PCA 9155 (supplied by Eckart GmbH & Co. KG), an aluminum effect pigment coated with synthetic resin having an average particle size d₅₀ of 18 μm in paste form (solids content 50% by weight) is used without further coating in the electrophoretic paint. Unlike Examples 1 to 3 of the invention, the polyol-modified polyester (SETAL 6306 SS-60, supplied by Akzo Nobel) was not introduced into the electrophoretic bath until the commercial anodic electrophoric paint (supplied by Frei Lacke) was introduced. The addition was therefore not performed as in Examples 1 to 3 of the invention by direct formation of a paste from the additive (coating composition) and the aluminum effect pigment prior to electrophoretic painting.

### COMPARATIVE EXAMPLE 8

PCA 9155 (supplied by Eckart GmbH & Co. KG), an aluminum effect pigment coated with synthetic resin and having an average particle size d₅₀ of 18 μm in paste form (solids content 50% by weight) without further coating. Unlike Examples 4 to 6 of the invention, the phosphoric acid-modified acrylate resin was not introduced into the electrophoretic bath until the commercial anodic electrophoric paint (supplied by Frei Lacke) was introduced. The addition was therefore not performed as in Examples 4 to 6 of the invention by direct formation of a paste from the additive (coating composition) and the aluminum effect pigment prior to electrophoretic painting.

### COMPARATIVE EXAMPLE 9

PCA 9155 (supplied by Eckart GmbH & Co. KG), an aluminum effect pigment coated with synthetic resin and having an average particle size d₅₀ of 18 μm in paste form (solids content 50% by weight) without further coating.

In this case no other additive (coating composition) was added to the electrophoric paint.

### Production of the Electrophoretic Paints and Testing Thereof

In each case, 26 g of the metal pigment paste of Examples 1 to 5 are mixed with 26 g of an acrylate resin (supplied by Emil Frei GmbH & Co. Lackfabrik-Am Bahnhof 6-D-78199 Braunlingen) in 26 g of butylglycol. This pigment paste is allowed to stand overnight.

Then the pigment paste is blended with 230 grams of a ready-mixed commercial anodic electrophoric paint based on acrylate and melamine with gentle stirring using a dissolver disk at 800 rpm, and an additional 36 g of demineralized water are added.

With stirring, 3.5 g of dimethanolamine in 170 g of demineralized water are added to this dispersion. After stirring for another 10 minutes, just enough distilled water is added with constant stirring to break the so-called “water mountain” such that the paint has a thin consistency (about 620 g of demineralized water).

The electrophoric paints prepared according to this formulation for anodic electrophoric painting are characterized by a viscosity of 9±1 seconds at a temperature of 20° C. measured in a DIN 4 flowcup. The solvent content of the bath is about 3.0% by weight, based on the total weight of the electrophoretic paint. The electrophoretic paints have a solids content of 12±0.1% by weight, based on the total weight of the electrophoretic paint. The content of aluminum pigments is about 1% by weight. The electrophoretic paint bath is found to have a pH of 8.2 at 25° C.

The electrochemical deposition method is carried out in an electrically conductive vessel, a so-called tank, consisting of an electrically conductive material and serving as the cathode in the circuit. The workpiece to be coated, in the exemplary embodiment of the invention a metal sheet measuring 7.5×15.5 cm, is wired as the anode and immersed to two thirds of its length in the electrophoretic paint bath.

In order to prevent sedimentation and the formation of dead spots, the bath is moved at an average flow speed of approx. 0.1 m/s. Subsequently, a voltage of 100 V is applied over a duration of 120 seconds. The workpiece thus coated is then thoroughly rinsed with distilled water in order to eliminate residues of uncoagulated resin. The workpiece is then allowed to dry in air for 10 minutes. Cross-linking and baking of the electrophoretic paint then take place over a period of 20 minutes at 180° C. The paint layer thus obtained has a thickness of 30±2 μm.

The electrophoretic paints produced according to Examples 1 to 6 of the invention have an extremely long shelf life and an extremely high deposition stability as regards the aluminum effect pigments present therein. This is clearly shown in Table 1. The paints were stored at room temperature and used for electrophoretic painting at intervals of 7 days. These tests were discontinued after 92 days.

Furthermore, samples of Examples 1 to 6 of the invention are stored for 30 days at 40° C. Then they were incorporated in an electrophoretic paint and applied electrophoretically in the manner described above. As regards the optical properties of the resulting coatings, no differences from those obtained using fresh samples were noticeable.

Examples 1 to 6 of the invention and the Comparative Examples 7 to 9 were also subjected to gassing tests. For this purpose, 25 g of the electrophoretic paints were heated at 40° C. in a gas bottle having a double chamber pipe attachment, and the quantity of evolved gas (H₂, which results from the reaction of the aluminum pigments with water) was measured. The test is considered to be passed if no more than 20 mL of hydrogen have evolved after 30 days.

The test results are summarized in Table 1

TABLE 1
Behavior of the anodic electrophoric paints

| | | Gassing |
|---|---|---|
| | Deposition stability | after 30 days |
| Sample | (in d) | (mL H₂) |
| Example 1 | >92 d | 5 |
| Example 2 | >92 d | 5 |
| Example 3 | >92 d | 5 |
| Example 4 | >92 d | 4 |
| Example 5 | >92 d | 5 |
| Example 6 | >92 d | 4 |
| Comparative Example 7 | <7 d | 5 |
| Comparative Example 8 | <7 d | 6 |
| Comparative Example 9 | <7 d | >30 mL |
| | | after 13 days |

Even after more than 92 days of storage time at room temperature, reproducible results in terms of the optical appearance of the coated test sheets were obtained for Examples 1 to 6 of the invention. They also displayed no appreciable gassing in the aqueous electrophoretic paints.

The pigments of Comparative Examples 7 and 8 were also gassing-stable but showed virtually no deposition stability. The aluminum pigments of Comparative Example 9 not provided with the coating of the invention are neither gassing stable nor do they have adequate deposition stability.

### COMPARATIVE EXAMPLE 10

### Powder Paint Containing Metal Pigment

9 g of a commercially available effect pigment for the powder paint, Spezial PCA 214 (supplied by Eckart GmbH & Co. KG) are intimately combined with 291 g of a powder varnish, (AL 96 Polyester PT 910 System (supplied by Du Pont) and 0.6 g of a so-called “free flow additive”, Acematt OK 412 (supplied by Degussa) in a plastic bag. The contents are then decanted directly into a mixing vessel resembling a commercial kitchen mixer in terms of construction and form (Thermomix supplied by Vorwerk), and then blended for 4 minutes at 25° C. at a medium stirring speed. This procedure corresponds to the “dry blend method” used in powder painting. The system thus produced is applied by means of a conventional corona charging technique (GEMA electrostatic spray gun PG 1-B) to a conventional test metal sheet (“Q-Panel”). The application conditions for the powder painting technique used here are the following: Powder hose connection: 2 bar; flushing air connection: 1.3 bar, voltage: 60 kV; material flow regulator: approx. 50%, distance of spray gun from the sheet metal: approx. 30 cm.

The powder painting system is then baked and cross-linked in an oven. The baking time is 10 minutes at a temperature of 200° C. The dry layer thickness achieved by this method is from 50 to 75 μm.

### COMPARATIVE EXAMPLE 11

### Powder Paint Containing Metal Pigment

Comparative Example 10 was repeated, except that Spezial PCA 9155 (supplied by Eckart GmbH & Co. KG) was used as metal effect pigment.

The various coating obtained in Examples 1 to 6 of the invention were compared with the substrates of Comparative Examples 10 and 11 coated by powder painting technology. For the purposes of comparative evaluation, aluminum effect pigments of similar particle size and color properties were used, as is apparent from Examples 1 to 6 of the invention and Comparative Examples 10-10.

The coatings achieved in Examples 1 to 6 of the invention surprisingly show excellent covering power equal, in terms of quality, to that of the powder paint coatings of Comparative Examples 10 and 11.

The optical characteristics are compared by way of observers' visual impressions. Surprisingly, it is found that Examples 1, 2, 4, and 5 show no appreciable differences in terms of brightness and metallic effect from conventional powder paint coatings produced in Comparative Examples 10 and 11.

Reference is made to DIN 53 230 when evaluating the optical properties. The properties and/or variations therein must often be evaluated subjectively when examining coating materials, paints, and similar coatings. DIN 53 230 specifies an evaluation system for such cases. It describes the manner in which test results should be evaluated when they cannot be referenced to directly determined measured values.

Reference is made to the “Fixed rating scale” explained in Section 2.1 of DIN 53 230 for evaluation of the Examples and Comparative Examples 1 to 11. The fixed rating scale is a scale for evaluating the intensity of the properties. The best possible value is referred to therein by the score 0, and the worst possible value by the score 5, where the term “worst possible value” means that any change or deterioration beyond this value is no longer of interest from the application engineering point of view.

The coloristic and optical properties determined with reference to DIN 53230, Section. 2.1, are listed in Table 2. The scores were determined by means of the subjective impressions of a number of persons. In all cases, agreement in the subjective impressions of the persons providing the evaluation could be established.

TABLE 2
Optical comparison of the electrophoretic paint coatings of Examples
1 to 6 of the invention and Comparative Examples 7 to 11

| | Average | | | |
|---|---|---|---|---|
| | particle | | | |
| | size | Covering | | |
| | d₅₀ | capacity | Brightness | General visual |
| Sample | [μm] | [score] | [score] | impression |
| Example 1 | 32 | 1 | 1 | very good metallic |
| of the invention | | | | sparkling effect |
| Example 2 | 16 | 0 | 1 | very metallic, |
| of the invention | | | | weaker |
| | | | | sparkling effect |
| Example 3 | 18 | 1 | 1 | very good metallic |
| of the invention | | | | leafing effect, high |
| | | | | luster, abrasion |
| | | | | resistant |
| Example 4 | 32 | 1 | 0 | very good metallic |
| of the invention | | | | sparkling effect |
| Example 5 | 16 | 0 | 1 | very metallic, |
| of the invention | | | | weaker |
| | | | | sparkling effect |
| Example 6 | 18 | 1 | 1 | very good metallic |
| of the invention | | | | leafing effect, high |
| | | | | luster, abrasion |
| | | | | resistant |
| Comparative | 16 | 3 | 3 | weaker metallic |
| Example 7 | | | | effect due to lack of |
| | | | | covering power |
| Comparative | 16 | 3 | 3 | weaker metallic |
| Example 8 | | | | effect due to lack of |
| | | | | covering power |
| Comparative | 18 | 5 | 5 | virtually no metal |
| Example 9 | | | | pigment deposited |
| Comparative | 32 | 0 | 1 | very good metallic |
| Example 10 | | | | sparkling effect |
| Comparative | 16 | 0 | 0 | very metallic, |
| Example 11 | | | | weaker |
| | | | | sparkling effect |

The above comparison shows that the pigments and pigment compositions developed according to the invention in Examples 1, 2, 4, and 5 are comparable in terms of their optical characteristics to powder coating pigments and applications that have been well-established on the market for many years. It clearly follows from the comparison of the scores of Examples 1, 2, 4, and 5, with Comparative Examples 10 and 11 that their optical characteristics are almost identical in terms of coverage, luster and metallic effect.

Examples 3 and 6 of the invention also show, surprisingly, an optical impression in an electrophoretic paint which is reminiscent of a conventional leafing paint. However, unlike conventional leafing paints, the coating was, surprisingly, abrasion-resistant.

Comparative Examples 8 and 9, in which the coating composition was introduced directly into the electrophoretic bath in the final stage of the electrophoretic bath production, display deviations. Clear losses in terms of coverage, luster, and the associated metallic effect are seen in this variant.

A metal pigment not treated in any way with a coating composition (Comparative Example 9) is virtually impossible to deposit in an anodic electrophoretic paint, although the metal pigment has a synthetic resin coating.

The conclusion to be drawn from the above is that it is clearly necessary to apply the coating composition (additive) directly to the pigment itself, as proposed by the invention, and not add it later to the paint bath. It is presumed that the additive with its pigmentophilic groups can form a physisorptive and/or chemisorptive bond to the pigment surface, which then appears to play a decisive key role in influencing the deposition properties of the pigment.

1. Electrophoretic pigments,
wherein the electrophoretic pigments are platelet-like metal pigments coated with at least one coating composition and the coating composition has
(a) one or more binder functionalities of anodic electrophoretic paint binders and
(b) one or more functional groups for effecting adhesion or binding to the pigment surface, and
(c) an acid value of from 15 to 300 mg KOH/g of coating composition.

2. The electrophoretic pigments according to claim 1,
wherein
said metal pigments are selected from the group consisting of leafing metal pigments, metal pigments coated with synthetic resin(s), and mixtures thereof.

3. The electrophoretic pigments according to claim 1,
wherein
said platelet-like metal pigments are of metals or alloys selected from the group consisting of aluminum, copper, zinc, brass, iron, titanium, chromium, nickel, steel, silver, and alloys thereof.

4. The electrophoretic pigments according to claim 1, wherein
said coating composition is capable of being deposited anodically.

5. The electrophoretic pigments according to claim 2,
wherein
the synthetic resin coating on the metal pigment comprises at least one acrylate and/or methacrylate.

6. The electrophoretic pigments according to claim 2,
wherein
said leafing metal pigment is a metal pigment which has been ground and/or finally polished in the presence of a fatty acid or fatty acids, which can contain linear or branched alkyl chains each preferably having from 10 to 30 carbons.

7. The electrophoretic pigments according to claim 6,
wherein
said fatty acid(s) include stearic acid and/or palmitic acid.

8. The electrophoretic pigments according to claim 1,
wherein
said binder functionalities are selected from the group consisting of polymerized polyepoxides, polyacrylates, polymethacrylates, polyesters, polymethanes, melamine resins, maleates, copolymers thereof, and mixtures thereof.

9. The electrophoretic pigments according to claim 1
wherein
the coating composition has one or more functional groups for effecting adhesion or binding to the pigment surface or comprises a synthetic resin surface applied to the metal pigment surface.

10. The electrophoretic pigments according to claim 9,
wherein the functional group is selected from the group consisting of phosphonic acids, phosphonic acid esters, phosphoric acids, phosphoric acid esters, carboxylates, sulfonates, polyols, and mixtures thereof.

11. The electrophoretic pigments according to claim 1
wherein
said coating composition is applied to the pigment in an amount equal to from 1 to 200% by weight, based on the weight of the metallic content of the pigment.

12. The electrophoretic pigments according to claim 1,
wherein
said coating composition is an electrophoretic paint binder.

13. A method for the production of electrophoretic pigments according to claim 1,
wherein
the method comprises the following steps:
(a) coating a metal pigment with the coating composition dissolved or dispersed in a solvent,
(b) optionally drying the metal pigments coated with the coating composition in step (a),
(c) optionally working the metal pigments dried in step (b) to a paste,
(d) optionally neutralizing the metal pigments obtained in step (a) or step (c).

14. The method according to claim 13,
wherein
the steps (a) and (b) are combined into one step by applying the coating composition as a solution or dispersion to metal pigments traveling in a stream of gas.

15. The use of electrophoretic pigments according to claim 1 in an electrophoretic paint or for electrophoretic painting.
